(19) United States
(12) Patent Application Publication
(10) Pub. No.: US 2015/0187002 A1
(43) Pub. Date: Jul. 2, 2015

(54) DUAL PRECISION COMPUTE FOR MONTE CARLO SIMULATION

(71) Applicant: BANK OF AMERICA CORPORATION, Charlotte, NC (US)

(72) Inventors: STEVEN ANTHONY GUCCIONE, AUSTIN, TX (US); KANISHKA HETTIARACHCHI, CHATHAM, NJ (US); DEAN ALLEN ANDERSON, NEW YORK, NY (US)

(21) Appl. No.: 14/145,976

(22) Filed: Jan. 1, 2014

(51) Int. Cl. G06Q 40/04; G06F 7/483; G06Q 30/02; G06Q 10/06

(52) U.S. Cl. CPC G06Q 40/04; G06Q 30/0283; G06Q 10/067; G06F 7/483

(57) ABSTRACT

Embodiments disclosed herein relate to systems, methods, and computer program products for a dual precision compute system for determining a price of a financial instrument using a Monte Carlo simulation. The system, method, and computer program product are configured to determine a model for calculating a price for a financial instrument using a Monte Carlo simulation; determine variables associated with the financial instrument; conduct a first portion of the Monte Carlo simulation with the variables using a first level precision; conduct a second portion of the Monte Carlo simulation with the variables using a second level precision, wherein the second level precision is higher than the first level precision; and determine the price of the financial instrument from the model. The first level precision may be a single precision floating point format and the second level precision may be a double precision floating point format.

### BACKGROUND

Financial institutions dedicate computer resources to performing calculations for the pricing of options using Monte Carlo methods. This technique is so pervasive that relatively exotic hardware in the form of Graphics Processing Units (GPUs) has been deployed in large numbers to specifically perform this and similar calculations.

Currently the GPU hardware as well as other similar hardware in other devices including mainstream CPUs supports at least two forms of floating point numeric representation. Two of these forms are generally referred to as Single Precision (SP) and Double Precision (DP). In general, financial calculations have opted for the more accurate double precision representation. This choice has usually been made because of a perceived or real increase in numerical accuracy and because modern CPUs typically perform single and double precision operations at very similar or even identical speeds.

GPU processors as well as most modern compute accelerators such as AVX vector units and even FPGAs offer significant performance improvements and/or cost savings for Single Precision over Double Precision. With some specific hardware, this difference can be as much as a factor of 5.

Thus, there is a need for a system and method that can perform these calculations efficiently using lower precision floating point numeric representations while maintaining the high accuracy of higher precision floating point numeric representations.

### BRIEF SUMMARY

The following presents a simplified summary of one or more embodiments of the disclosure in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments disclosed herein address the above needs and/or achieve other advantages by providing an apparatus (e.g., a system, computer program product, and/or other device) and a computer-implemented method for performing a dual precision compute for a Monte Carlo simulation. The dual precision compute allows for the use of high speed, efficient lower precision floating point representations at earlier stages of the Monte Carlo simulation and then transitions to the less efficient but more accurate higher precision floating point representations at later stages of the Monte Carlo simulation.

In a first aspect, a dual precision compute system for Monte Carlo simulation is provided. In some embodiments, the system includes a computing device processor; a storage device; and a dual precision compute Monte Carlo application stored in said storage device and configured for operation on said computing device processor, said application configured to: determine a model for calculating a price for a financial instrument using a Monte Carlo simulation; determine variables associated with the financial instrument; conduct a first portion of the Monte Carlo simulation with the variables using a first level precision; conduct a second portion of the Monte Carlo simulation with the variables using a second level precision, wherein the second level precision is higher than the first level precision; and determine the price of the financial instrument from the model.

In some embodiments, the application is further configured to transition from the first level precision to the second level precision. For example, the application may transition from the first level precision to the second level precision when 50% of the Monte Carlo simulation is complete. In another example, the application transitions from the first level precision to the second level precision when the low order bits of the result stabilize. In a still further example, the application transitions from the first level precision to the second level precision based on an algorithm determined via test runs.

In some embodiments, the first level precision is single precision floating point format and the second level precision is double precision floating point format. In further embodiments, the financial instrument is selected from the group consisting of an option and a derivative. In still further embodiments, the application is further configured to transition from the first level precision to the second level precision by assignment.

In a second aspect, a dual precision computer program product for determining a financial instrument price using a Monte Carlo simulation is provided. In some embodiments, the computer program product includes a non-transitory computer-readable medium comprising: an executable portion for causing a computer to determine a model for calculating a price for a financial instrument using a Monte Carlo simulation; an executable portion for causing a computer to determine variables associated with the financial instrument; an executable portion for causing a computer to conduct a first portion of the Monte Carlo simulation with the variables using a first level precision; an executable portion for causing a computer to conduct a second portion of the Monte Carlo simulation with the variables using a second level precision, wherein the second level precision is higher than the first level precision; and an executable portion for causing a computer to determine the price of the financial instrument from the model.

In some embodiments, the non-transitory computer-readable medium further comprises an executable portion for causing a computer to transition from the first level precision to the second level precision. In an embodiment, the first level precision transitions to the second level precision when 50% of the Monte Carlo simulation is complete. In further embodiments, the first level precision transitions to the second level precision when the low order bits of the result stabilize. In still further embodiments, the first level precision transitions to the second level precision based on an algorithm determined via test runs.

In some embodiments, the first level precision is single precision floating point format and the second level precision is double precision floating point format. In further embodiments, the financial instrument is selected from the group consisting of an option and a derivative. In yet still further embodiments, the computer program product includes an executable portion for causing a computer to transition from the first level precision to the second level precision by assignment.

In a third aspect, a computer-implemented method of determining a price of a financial instrument using a dual precision compute Monte Carlo simulation is provided. In some embodiments, the method includes determining a model for calculating a price for a financial instrument using a Monte Carlo simulation; determining variables associated with the financial instrument; conducting, via a computing device processor, a first portion of the Monte Carlo simulation with the variables using a first level precision; conducting, via a computing device processor, a second portion of the Monte Carlo simulation with the variables using a second level precision, wherein the second level precision is higher than the first level precision; and determining the price of the financial instrument from the model.

In some embodiments, the method includes transitioning from the first level precision to the second level precision when 50% of the Monte Carlo simulation is complete. In some embodiments, the first level precision is single precision floating point format and the second level precision is double precision floating point format. In further embodiments, the financial instrument is selected from the group consisting of an option and a derivative.

Other aspects and features, as recited by the claims, will become apparent to those skilled in the art upon review of the following non-limited detailed description of the disclosure in conjunction with the accompanying figures.

### BRIEF DESCRIPTION OF THE SEVERAL VIEWS OF THE DRAWINGS

Having thus described embodiments in general terms, reference will now be made to the accompanying drawings, which are not necessarily drawn to scale, and wherein:

FIG. 1 provides a high-level flow chart illustrating a computer-implemented method of providing a dual precision compute system for Monte Carlo simulation, in accordance with one embodiment of the present disclosure;

FIG. 2 provides a graph of Monte Carlo option speedup for single and double precision in two different types of hardware, in accordance with one embodiment of the present disclosure;

FIG. 3 provides a graph of a comparison of run time for single precision, double precision, and dual precision Monte Carlo simulations, in accordance with one embodiment of the present disclosure;

FIG. 4 provides a graph of the improvement of double precision compared to dual precision Monte Carlo simulations based on the number of trials performed, in accordance with one embodiment of the present disclosure;

FIG. 5 provides a graph of Monte Carlo options put error based on the number of trials for single precision, double precision, and dual precision, in accordance with one embodiment of the present disclosure;

FIG. 6 provides a graph of Monte Carlo options call error based on the number of trials for single precision, double precision, and dual precision, in accordance with one embodiment of the present disclosure; and

FIG. 7 provides exemplary code for implementing the dual precision Monte Carlo method, in accordance with one embodiment of the present disclosure.

### DETAILED DESCRIPTION

Embodiments will now be described more fully hereinafter with reference to the accompanying drawings, in which some, but not all, embodiments are shown. Indeed, the disclosure may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” It should also be understood that while some embodiments describe the methods or products as comprising one or more elements, the methods or elements may also consist of or consist essentially of the elements disclosed herein.

It should be understood that terms like “bank,” “financial institution,” and “institution” are used herein in their broadest sense. Institutions, organizations, or even individuals that process financial transactions are widely varied in their organization and structure. Terms like “financial institution” are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire method and system on their own computer systems or even a single work station if appropriate databases are present and can be accessed.

In one embodiment, the dual precision Monte Carlo calculation technique takes advantage of the difference in compute performance by mixing lower precision, such as Single Precision, and higher precision, such as Double Precision, in a way that will improve overall performance while causing a minimal, if any, decrease in numeric accuracy of the final result. Other types of floating point accuracy may also be used. For example, a quadruple precision floating point accuracy may be used instead of or in addition to single precision and double precision. Furthermore, in some embodiments, the format can be other than floating point. For example, integer calculations or any other number system that has an advantage for lower precision such as INTEL® SSE may work in this system.

In some embodiments, any hardware system having an advantage for one type of numbers format over another type of numbers format can use this technique effectively. For example, some hardware systems have an advantage in speed and efficiency in using single precision floating point over double precision. Graphical processing units (GPUs) and modern vector units such as INTEL® AVX are examples.

The dual precision Monte Carlo calculation technique takes advantage of the fact that Monte Carlo simulations successively approximate a result over thousands or even millions of iterations. During the early portions of this calculation, only high order bits in the digital representation converge toward the actual solution. It is only in later stages of the computation, after some level of accuracy has been established, that the lower order bits of the digital representation follow and converge to the higher precision solution.

In some embodiments, the dual precision Monte Carlo calculation technique performs some early portion of the calculation in Single Precision mode, and then once some level of accuracy has been established, switches to the more accurate Double Precision mode. For example, the system may switch from single precision to double precision at the midpoint of the simulation. Tests indicate that this will significantly increase performance on devices such as GPUs while having little or no impact on numeric accuracy.

While the examples disclosed herein will reference using the dual precision Monte Carlo calculation technique to determine option pricing, it should be understood that the technique may be used to evaluate characteristics of and price other types of financial instruments, such as derivatives, mortgages and other types of loans, bonds, annuities, or investment devices. In some embodiments, the method and system can be used to value portfolios, which can then be used for uncertainty analysis. The portfolio pricing is useful for both reporting and trading. The system and method disclosed herein may also be used for evaluating uncertainty under different scenarios. In some embodiments, the system and method are used for credit valuation adjustment.

As used herein, an option is a financial derivative that represents a contract sold by one party (option writer) to another party (option holder). The contract offers the buyer the right, but not the obligation, to buy (call) or sell (put) a security or other financial asset at an agreed-upon price (the strike price) during a certain period of time or on a specific date (exercise date). Call options give the option to buy at a certain price, so the buyer would want the stock to go up. Put options give the option to sell at a certain price, so the buyer would want the stock to go down. The option may be an American option, European option, Asian option, lookback option, or other type of option.

Pricing of options is a process that takes into account various variables associated with the option, which may include the underlying asset price, the strike price, the intrinsic value, multiple types of volatility, interest rates, dividends paid, time value, currency fluctuations, and the time until expiration of the option. Various pricing models may be used to determine a price for a put or sell option. For example, the Black-Scholes model is a well-known model for determining European option prices. As is known to one skilled in the art, different models are advantageous when determining option pricing for different types of options and when different variables are available. In other examples, the binomial options pricing model, the finite difference methods, the Heston model, the Heath-Jarrow-Morton framework, the Variance gamma model, and Monte Carlo option models.

In some embodiments, option pricing is determined using a Monte Carlo simulation method. Use of a Monte Carlo simulation for option pricing is well known. However, Monte Carlo simulation is typically performed using only a single type of precision format. For example, Monte Carlo simulation for pricing options may be performed using only double-precision floating point format. In general, the Monte Carlo simulation generates a large number of possible price paths for an asset, e.g., a stock, a bond, and the like, via simulation. The exercise value of the option for each path is determined, the payoffs are averaged and then discounted to today.

The Monte Carlo simulation may be made more complex by modeling additional sources of uncertainty, such as the price of the underlying asset, the annualized interest rate, the exchange rate, correlation between underlying sources of uncertainty, commodity prices, inflation, multiple underlying assets, correlation between multiple types of asset returns, and other types of uncertainty.

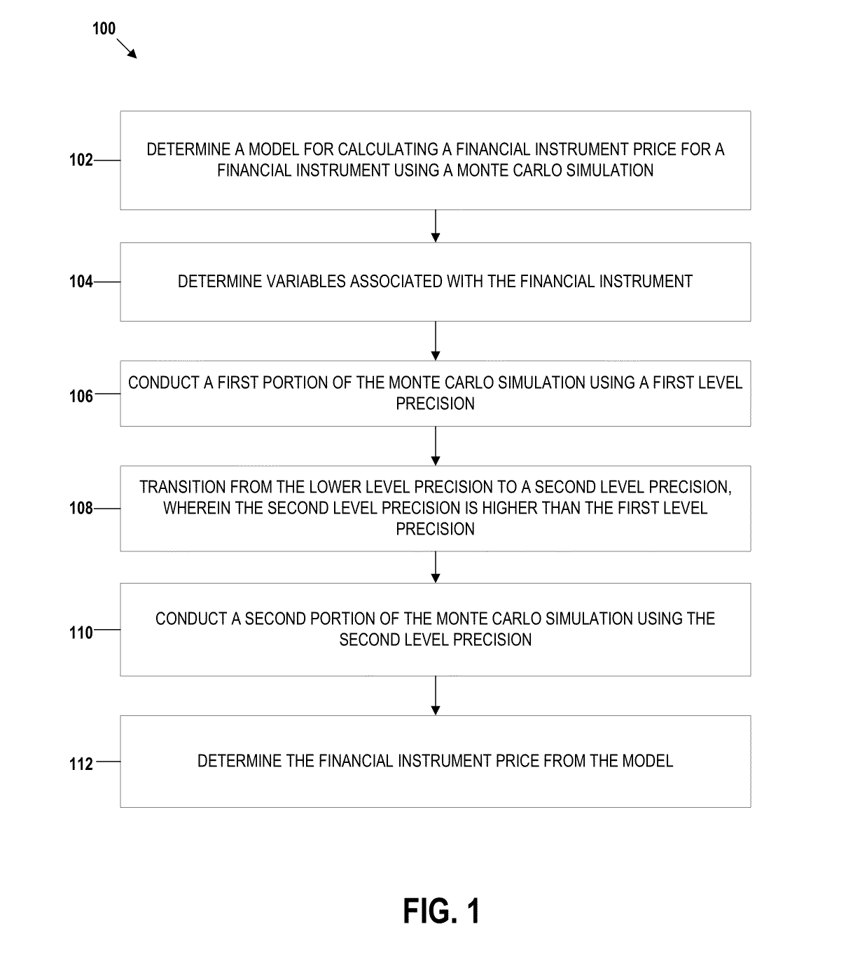

Turning now to FIG. 1, an example of a computer-implemented method that may be implemented using a system as disclosed herein is provided. In some embodiments, the computer-implemented method determines a model for calculating a financial instrument price for a financial instrument using a Monte Carlo simulation, determines variables associated with the financial instrument, conducts a first portion of the Monte Carlo simulation using a first level precision, transitions from the first level precision to a second level precision, wherein the second level precision is higher than the first level precision, conducts a second portion of the model using the second level precision, and determines the financial instrument price from the model.

In block 102, the system determines a model for calculating a financial instrument price of a financial instrument using a Monte Carlo simulation. In an exemplary embodiment, the model is determined based on the type of financial instrument that will be priced. For example, a bond option that will be priced may use a model that considers both the underlying bond price and the annualized interest rate of the bond. The model that is determined for pricing the financial instrument may be targeted to the specific financial instrument type and/or may be determined based on the data that are available to the system or financial institution. In another example, an option based on a stock denominated in a foreign currency may have a model that includes the underlying stock price and the exchange rate between the foreign currency and the currency that the option will be priced in. In some embodiments, a least square Monte Carlo method is used.

In an embodiment, the model includes one or more sources of uncertainty that affect the path of the financial instrument during the simulation. Path dependent structures such as Asian options may therefore be priced using Monte Carlo simulation models. One skilled in the art would understand that the types of uncertainty and types of models discussed herein are not limiting but provided to inform the skilled practitioner with examples that may be expanded upon to include other types of models, uncertainty, and variables.

In block 104, the system determines variables associated with the financial instrument. The variables are used in the model for calculating the financial instrument price and may include values representing the underlying asset, e.g., stock or index, price, the strike price, the time until the option expires, and other variables used in the model. These variables may be measurements of the underlying uncertainty associated with the option. For example, a variable may be the inflation rate or commodity price associated with an underlying asset.

The variables may be received from the financial institution or from an external source, such as a governmental agency, another financial institution, or a third party analyst. In some embodiment, the variables are public information, such as the exchange rate between two currencies. In further embodiments, the variables are proprietary information, such as the correlation determined between two variables based on a proprietary algorithm.

As should be known, many different variables corresponding to different types of uncertainty that may be evaluated in a Monte Carlo simulation are possible. The variables disclosed herein are merely examples and are not intended to be limiting.

In block 106, the system conducts a first portion of the Monte Carlo simulation using a first level precision. The first level precision is a type of computer number format for the internal representation of numeric values in digital computer and calculator hardware and software. In some embodiments, the first level precision is single precision floating point format. As is known, the single precision computer number format occupies 4 bytes (32 bits) in computer memory. While the examples provided herein disclose use of single precision as the first level precision, other types of computer number formats may be used.

The precision of the computer number format affects the efficiency and speed of analysis of Monte Carlo simulations on computing devices. A lower precision may be used to quickly conduct a Monte Carlo simulation but results in higher error. A higher precision takes longer to conduct a Monte Carlo simulation but is more accurate.

In an embodiment, the first portion of the Monte Carlo simulation is the beginning portion of the Monte Carlo simulation. The first portion may be up to a predetermined amount of the simulation. For example, the first portion of the Monte Carlo simulation may be 50% of the Monte Carlo simulation. In some embodiments, the first portion is defined by a percentage of the full simulation length, e.g., 30%, 40%, 50%, 60%, 70% or the like. In further embodiments, the first portion is determined based on a comparison between model data and simulation data. For example, a comparison between a Monte Carlo simulation and a Black-Scholes calculation for option pricing of a European option may show that the first portion is limited to 35% of the entire simulation in order to minimize error relative to the Black-Scholes calculation.

In block 108, the system transitions from the first level precision to a second level precision. In an embodiment, the second level precision is a higher level precision than the first level precision. For example, the second level precision may be a double precision floating point format. As is known, a double precision floating point format is a computer number format that occupies 8 bytes (64 bits) in computer memory. Depending on hardware used, a higher level precision, such as a double precision compared to a single precision, are usually slower to execute but have greater accuracy. A Monte Carlo simulation model performed with a double precision format make take longer but has less error compared to a known solution compared to a single precision format.

In some embodiments, the transition occurs from single to double precision based on monitoring the low order bits of the result. When the low order bits stabilize, the accuracy has run out. In some embodiments, evaluating the low order bits will occur after a few iterations have already occurred, such as on the order of five iterations, in order to avoid identification of bits that have stayed the same based on random chance on not expiration of the single precision accuracy.

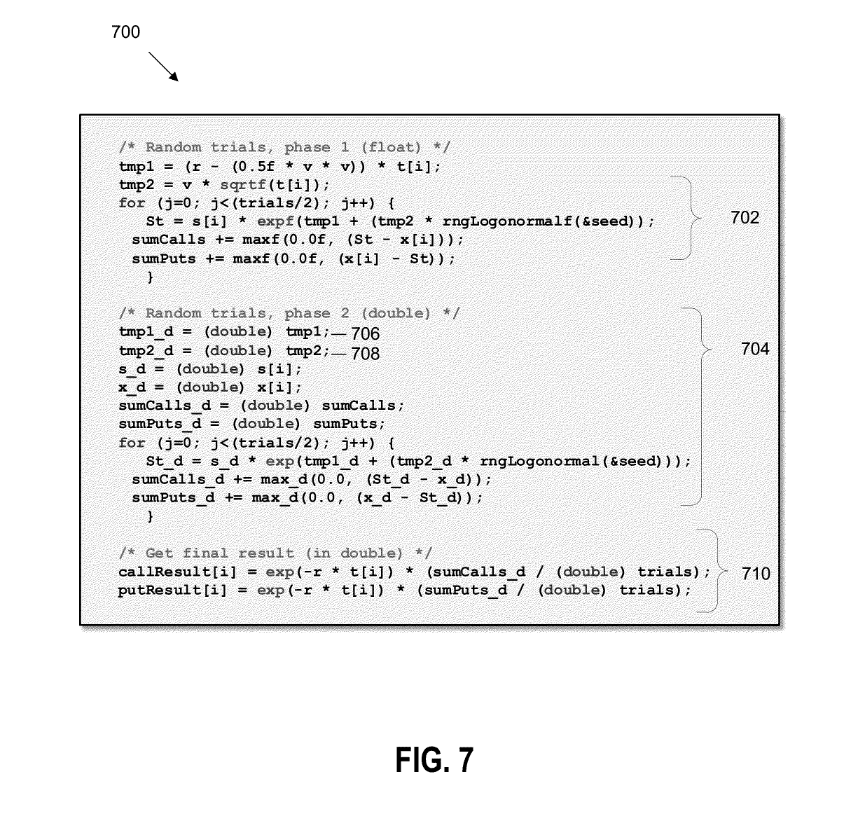

In an embodiment, transitioning from the first level precision to the second level precision comprises assigning numbers from the first level precision to the second level precision. Turning briefly to FIG. 7, the assignment from the first precision format (e.g., single) to the second precision format (e.g., double) occurs at 706 and 708. In further embodiments, transitioning results in transformation of the numbers in the simulation. The numbers may be transformed via an algorithm or to translate the first format into a second format.

As discussed, transitioning from the first level precision to the second level precision occurs at a specific point in the Monte Carlo simulation. The point at which the transition occurs may be a predetermined completion level of the simulation, e.g., 50% complete, or it may be determined via modeling data in order to optimize the process through minimizing time and error.

In block 110, the system conducts a second portion of the Monte Carlo simulation using the second level precision. In an embodiment, the second level precision is a higher level precision, such as double precision when the first level precision is single precision.

In an embodiment, the second portion is a segment of the Monte Carlo simulation from the transition to the end of the simulation. For example, the first portion of the Monte Carlo simulation may be performed using single precision numbers format and then the Monte Carlo simulation may transition to double precision and complete the Monte Carlo simulation. This results in a compromise between speed and accuracy. Given that the single precision format is accurate for early stages of a simulation, the decline in accuracy is minimal compared to the gain in efficiency and speed. When resources are at a premium, the dual precision compute system for the Monte Carlo simulation effectively utilizes resources with acceptable increases in error.

In some embodiments, multiple levels of precision are used in a single Monte Carlo simulation. For example, a third level of precision may be used after the second level of precision. The Monte Carlo simulation may transition between the second level precision and the third level precision at a predetermined point or based on an optimization model. While the examples disclosed herein present two levels, i.e., single and double, in a dual precision compute system, more than two levels are possible in a multi-precision compute system.

In block 112, the system determines the financial instrument price from the model. Upon completion of the Monte Carlo simulation, the financial instrument can be priced based on the result of the simulation. This financial instrument pricing can be used to value portfolios, which can then be used for uncertainty analysis. The portfolio pricing is useful for both reporting and trading.

The system and method disclosed herein may also be used for evaluating uncertainty under different scenarios. For example, the system and method can be used to evaluate the value of a portfolio is interest rates rise 0.25%. In some embodiments, the system and method are used for credit valuation adjustment.

The flow chart of FIG. 1 illustrates general principles and embodiments of the system and computer-implemented method of providing a dual precision compute system for Monte Carlo simulation. The examples included herein are not limiting and as will be discussed in greater detail later additional steps and or features may be included in the systems and computer-implemented methods.

### EXAMPLES

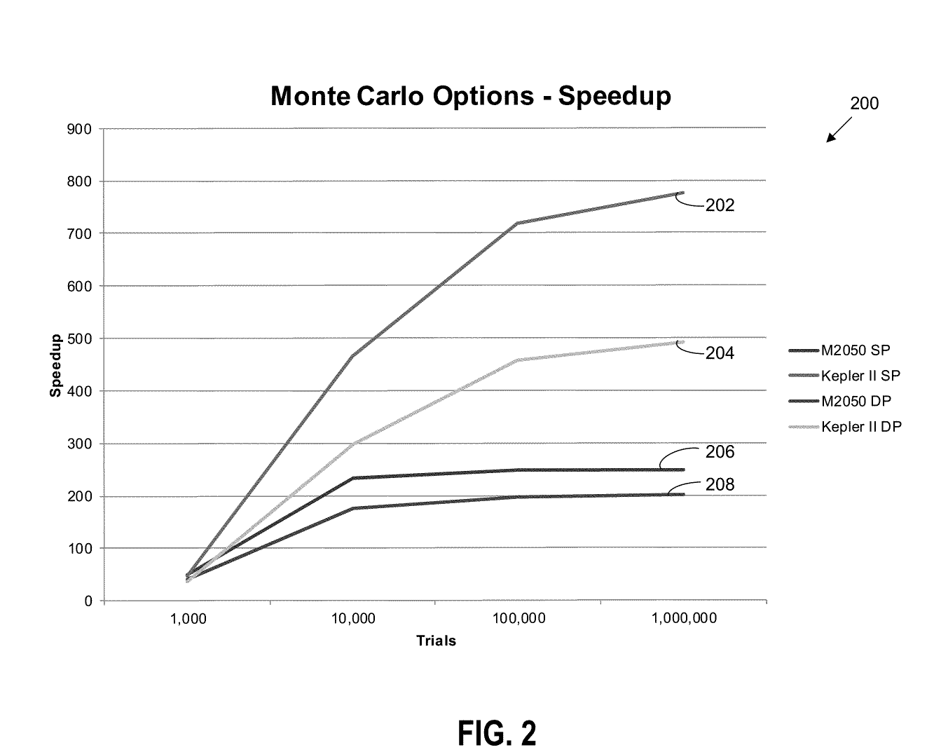

Example 1 shown in FIG. 2 provides a comparison 200 of speedup for Monte Carlo simulations using a lower level precision (i.e., single precision) and a higher level precision (i.e., double precision) with two types of hardware. In FIG. 2, the speedup in a Monte Carlo simulation for two types of hardware devices, an M2050 graphics processing unit (GPU) and a Kepler II GPU, manufactured by NVIDIA® is compared for single precision (SP) and double precision (DP). The Kepler II single precision 202 has greater speedup than the Kepler II double precision 204, and the M2050 single precision 206 has greater speedup than the M2050 double precision 208. As seen in FIG. 2, when a Monte Carlo simulation is run in single precision, the speedup is increased compared to when a Monte Carlo simulation is run in double precision for a single type of hardware. Different types of hardware have different levels of speedup. For example, the Kepler II GPU has a larger difference in speedup for single precision compared to double precision than the M2050 GPU. The system and method disclosed herein takes advantage of the increased speedup of single precision format in the early stages of a Monte Carlo simulation, while switching to double precision at a later point in order to increase accuracy.

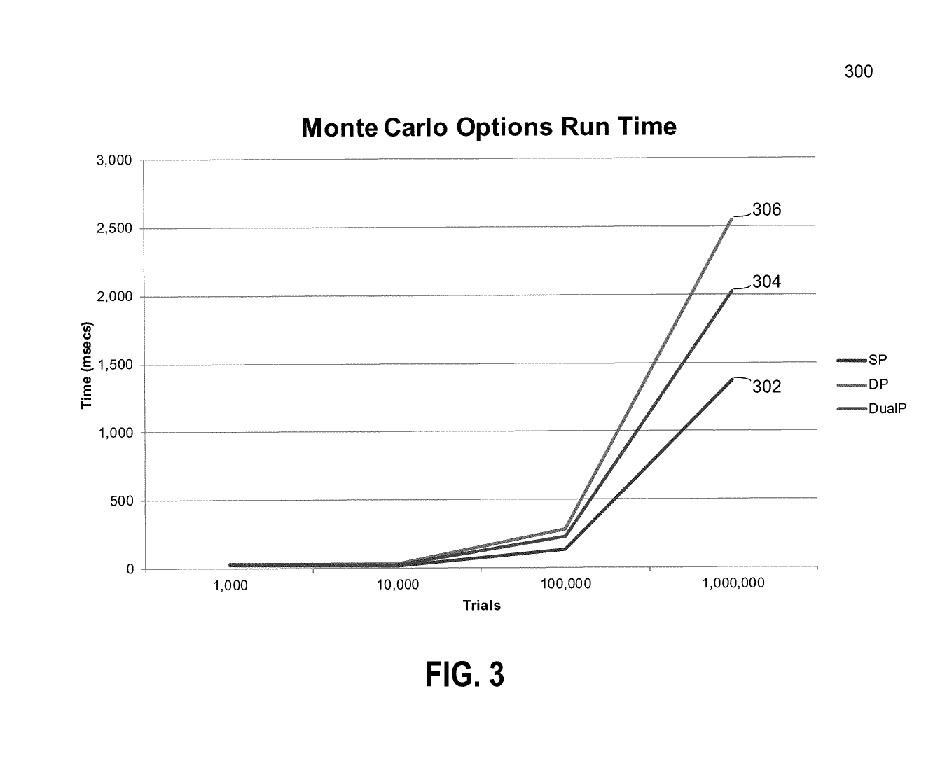

Example 2, shown in FIGS. 3-6, provides an evaluation of the dual precision compute technique for Monte Carlo simulation. In this embodiment, the dual precision compute technique comprises a first portion of single precision and then a transition to double precision when 50% of the simulation is complete. The simulation was run on an Nvidia Kepler II GPU using CUDA 4.2 software. In other embodiments, the simulation can be run on, for example, an Intel E5-2670 CPU as found on HP SL230 and Dell C6220 systems.

In FIG. 3, the performance of dual precision compared to double precision alone or single precision alone is provided. As shown, the dual precision 304 is between the single precision 302, which is faster, and the double precision, 306, which is slower. The difference in runtime increases as the number of trials increases in the simulation. This result indicates that the dual precision compute method is a tradeoff between the single precision speed and the double precision speed.

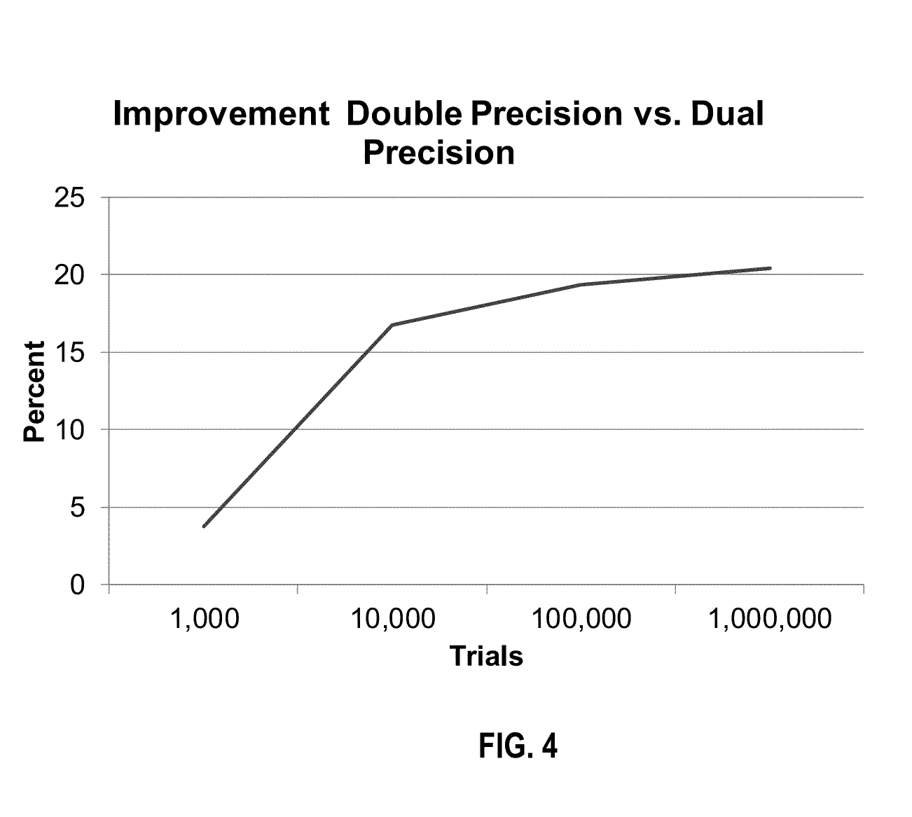

In FIG. 4, the performance of dual precision compared to double precision is provided. Given that a Monte Carlo simulation performed solely in double precision uses a more accurate numbers format than the single precision used in the initial portion of the dual precision Monte Carlo simulation, it is expected that double precision shows an improvement over dual precision. As shown in FIG. 4, for this example the improvement in double precision is approximately 20% compared to dual precision. The improvement indicates a decrease in execution time, which is an increase in performance. The performance improvement levels off as the number of trials in the simulation increases.

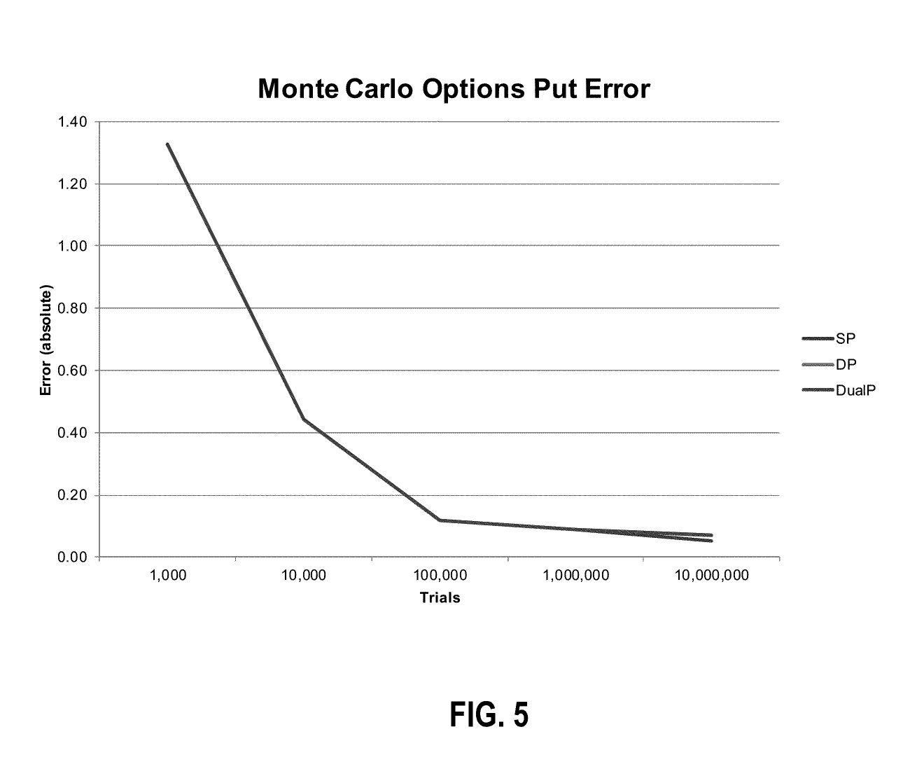

In FIG. 5, the absolute error of the dual precision method compared to single precision alone and double precision alone is provided for put options. In FIG. 5, a comparison between the Monte Carlo simulation and the Black-Scholes model for pricing a put option was performed. The comparison allows for a determination of the absolute error between the price determined by the Monte Carlo simulation and the price determined by the Black-Scholes model. As shown, the absolute error between the Monte Carlo simulation and the Black-Scholes model decreases as the numbers of trials increases. At high numbers of trials, small separation occurs in the error between single precision, double precision, and dual precision, although the difference in error between the different types of number formats used in the Monte Carlo simulation is minimal. FIG. 7 discloses exemplary code for implementing the Monte Carlo simulation.

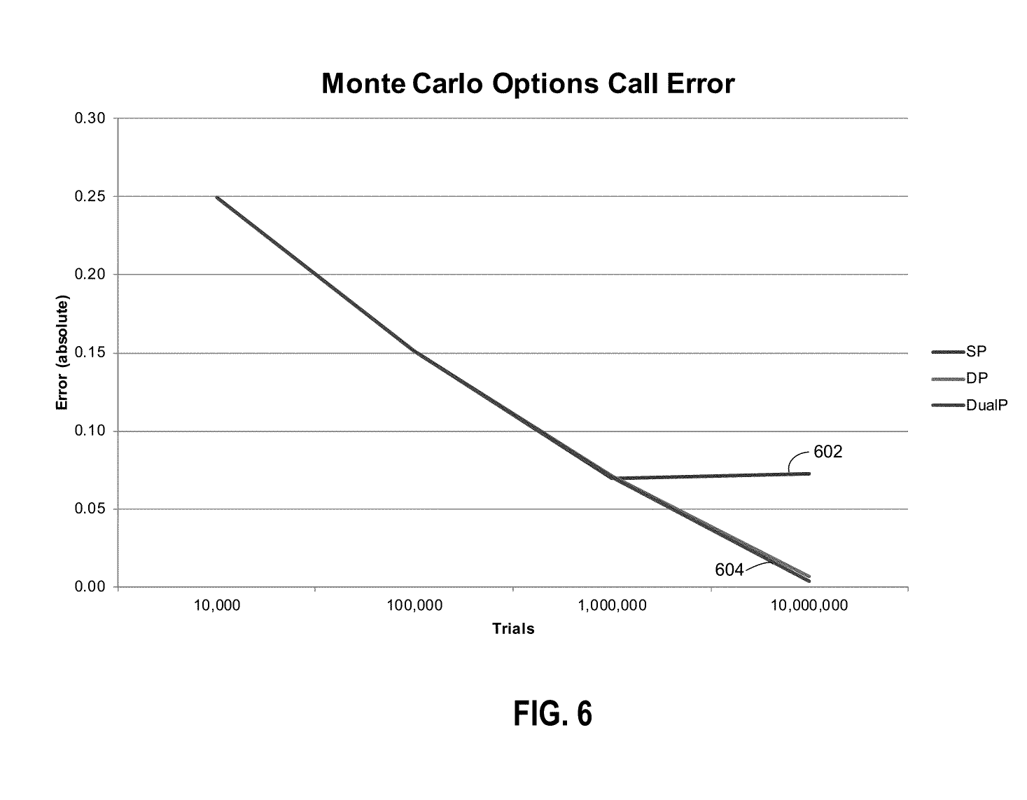

In FIG. 6, the absolute error of the dual precision method compared to single precision alone and double precision alone is provided for calls. Similar to FIG. 5, this graph displays the absolute error in a call price determined based on the difference between the price determined by a Monte Carlo simulation and the price determined based on the Black-Scholes model. As the number of trials increases in the Monte Carlo simulation, the absolute error between the price determined by the simulation and the price determined by the model decreases. Unlike in FIG. 5, however, as the number of trials increases over 1,000,000 the absolute error for the single precision 602 remains higher than the absolute error for the double precision and dual precision 604. This shows that while single precision is faster, as shown in FIGS. 2 and 3, it may introduce greater error than dual precision or double precision. This also shows the limits of accuracy given the lower accuracy of single precision. Once the limit of the accuracy of the numeric representation (single precision) is reached, the flattening of the curve appears. This is one reason for switching to double: to get higher accuracy.

FIG. 7 provides exemplary code 700 for implementing the dual precision compute system for Monte Carlo simulations. The exemplary code discloses using the dual precision compute system to perform a Monte Carlo simulation for pricing European options. In the code, section 702 implements the first portion of the Monte Carlo simulation using single precision floating point format. Section 704 implements the second portion of the Monte Carlo simulation in double precision format. The transition from single precision to double precision occurs via assignment at lines 706 and 708. In section 710, the final result is determined for calls and puts.

The computer-implemented methods, computer program products, and apparatuses described herein provide a technical effect to solve a technical problem. At a minimum, the computer-implemented methods, computer program products, and apparatuses described herein reduce the wasted resources expended by financial systems by more efficiently computing financial instrument pricing using a dual precision compute system for Monte Carlo simulation.

It is understood that the servers, systems, and devices described herein illustrate one embodiment. It is further understood that one or more of the servers, systems, and devices can be combined in other embodiments and still function in the same or similar way as the embodiments described herein.

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present disclosure may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as, for example, a propagation signal including computer-executable program code portions embodied therein.

One or more computer-executable program code portions for carrying out operations of the present disclosure may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F#.

Some embodiments of the present disclosure are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present disclosure.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the disclosure. Therefore, it is to be understood that, within the scope of the appended claims, the disclosure may be practiced other than as specifically described herein.

What is claimed is:

1. A dual precision compute system for Monte Carlo simulation, the system comprising:
a computing device processor;
a storage device; and
a dual precision compute Monte Carlo application stored in said storage device and configured for operation on said computing device processor, said application configured to:
determine a model for calculating a price for a financial instrument using a Monte Carlo simulation;
determine variables associated with the financial instrument;
conduct a first portion of the Monte Carlo simulation with the variables using a first level precision;
conduct a second portion of the Monte Carlo simulation with the variables using a second level precision, wherein the second level precision is higher than the first level precision; and
determine the price of the financial instrument from the model.

2. The system of claim 1, wherein the application is further configured to transition from the first level precision to the second level precision.

3. The system of claim 2, wherein the application transitions from the first level precision to the second level precision when 50% of the Monte Carlo simulation is complete.

4. The system of claim 2, wherein the application transitions from the first level precision to the second level precision when the low order bits of the result stabilize.

5. The system of claim 2, wherein the application transitions from the first level precision to the second level precision based on an algorithm determined via test runs.

6. The system of claim 1, wherein the first level precision is single precision floating point format and the second level precision is double precision floating point format.

7. The system of claim 1, wherein the financial instrument is a derivative.

8. The system of claim 1, wherein the application is further configured to transition from the first level precision to the second level precision by assignment.

9. A dual precision computer program product for determining a financial instrument price using a Monte Carlo simulation, the computer program product comprising:
a non-transitory computer-readable medium comprising:
an executable portion for causing a computer to determine a model for calculating a price for a financial instrument using a Monte Carlo simulation;
an executable portion for causing a computer to determine variables associated with the financial instrument;
an executable portion for causing a computer to conduct a first portion of the Monte Carlo simulation with the variables using a first level precision;
an executable portion for causing a computer to conduct a second portion of the Monte Carlo simulation with the variables using a second level precision, wherein the second level precision is higher than the first level precision; and
an executable portion for causing a computer to determine the price of the financial instrument from the model.

10. The computer program product according to claim 9, wherein the non-transitory computer-readable medium further comprises an executable portion for causing a computer to transition from the first level precision to the second level precision.

11. The computer program product according to claim 10, wherein the first level precision transitions to the second level precision when 50% of the Monte Carlo simulation is complete.

12. The computer program product according to claim 10, wherein the first level precision transitions to the second level precision when the low order bits of the result stabilize.

13. The computer program product according to claim 10, wherein the first level precision transitions to the second level precision based on an algorithm determined via test runs.

14. The computer-program product according to claim 9, wherein the first level precision is single precision floating point format and the second level precision is double precision floating point format.

15. The computer-program product according to claim 9, wherein the financial instrument is selected from the group consisting of an option and a derivative.

16. The computer-program product according to claim 9, further comprising an executable portion for causing a computer to transition from the first level precision to the second level precision by assignment.

17. A computer-implemented method of determining a price of a financial instrument using a dual precision compute Monte Carlo simulation, the method comprising:
determining a model for calculating a price for a financial instrument using a Monte Carlo simulation;
determining variables associated with the financial instrument;
conducting, via a computing device processor, a first portion of the Monte Carlo simulation with the variables using a first level precision;
conducting, via a computing device processor, a second portion of the Monte Carlo simulation with the variables using a second level precision, wherein the second level precision is higher than the first level precision; and
determining the price of the financial instrument from the model.

18. The computer-implemented method of claim 17, further comprising transitioning from the first level precision to the second level precision when 50% of the Monte Carlo simulation is complete.

19. The computer-implemented method of claim 17, wherein the first level precision is single precision floating point format and the second level precision is double precision floating point format.

20. The computer-implemented method of claim 17, wherein the financial instrument is a derivative.
